(19) United States
(12) Patent Application Publication
(10) Pub. No.: US 2006/0271985 A1
(43) Pub. Date: Nov. 30, 2006

(54) Peripheral unit for upstream cable television system communication

(76) Inventors: Wesley O Hoffman, Los Gatos, CA (US); Gary M. Lauder, Atherton, CA (US)

Correspondence Address: BROMBERG & SUNSTEIN LLP, 125 SUMMER STREET, BOSTON, MA, 02110-1618, US

(21) Appl. No.: 10/544,131

(22) PCT Filed: Feb. 2, 2004
(86) PCT No.: PCT/US04/02901

§ 371 Date: Apr. 24, 2006

(30) Foreign Application Priority Data
Feb. 5, 2003 (US) 60445279

(51) Int. Cl. H04N 7/173; H04N 7/18

(52) U.S. Cl. 725/111; 725/80; 725/120

(57) ABSTRACT

A device and method for an interactive cable television system is described. A hardware peripheral device is associated with a modem in communication with a computer network. The peripheral device receives data from a user for communication via the computer network to a cable television network head end to control a television information signal delivered from the cable television network directly to a user television.

### FIELD OF THE INVENTION

The invention relates to cable television networks, and more specifically, to a peripheral device for end users of an interactive cable television network.

### BACKGROUND ART

Cable television operators have the capability to provide various interactive services to home users such as video-on-demand (VOD), email, games, Internet access, and walled-garden content. These interactive services require the home user to get commands from the home (via a keyboard, remote control, mouse, joystick or similar device) back up to the head end of the cable operator. Cable operators face significant capital costs for installing return path equipment on a television network. For example, one approach used by Motorola and Scientific Atlanta is to install a separate proprietary return path system to support their particular set-top boxes.

The cable television industry and major television providers have agreed on a plan for providing digital cable-ready televisions that will have capability to receive digital channels, but so far the specifications do not include a designated return path capability. However, many cable operators have already installed return path capability required for cable modems to communicate to separate computer networks using a separate data network on the same cable carrying the television network. With new and emerging technologies, cable operators can now offer cable TV, broadband Internet access, and telephone access to travel simultaneously via the same coaxial cable.

### SUMMARY OF THE INVENTION

A representative embodiment of the present invention includes a device and method for an interactive cable television system. A hardware peripheral device is coupled to a computer modem at a user premises and in communication with a computer network. The peripheral device communicates via the modem over the computer network to a cable television network head end to control a television information signal provided over a cable television network cable connected directly to a digital cable ready television at the user premises. As used herein, “directly” means without intervening processing devices in the user premises, e.g., a set top box.

An embodiment also includes an interactive cable television system including a computer network and a computer modem at a user premises and in communication with the computer network. A cable television network including a head end provides a television information signal over a cable television network cable directly to a digital cable ready television at the user premises, the television having a display responsive to the television information signal. A hardware peripheral device is coupled to the modem for communicating data from a user via the computer network to the head end to control the television information signal.

Another embodiment includes a hardware peripheral device having a receiver for receiving data from a user input device, a processor responsive to the data for sending communications through a computer modem at a user premises over a computer network to a cable television network head end, and an output for controlling a television information signal: (a) provided by a cable television network cable connected directly to a digital cable ready television at the user premises, (b) from the head end responsive to the communications from the hardware peripheral device.

An embodiment also includes an interactive cable television system having a computer modem at a user premises and in communication with a computer network; a user input device; a hardware peripheral device having a receiver for receiving data from the user input device, and a processor responsive to the data for sending communications through the computer modem to a cable head end; and a digital cable ready television at the user premises and directly connected to a cable television network cable for displaying a television information signal provided over the cable from the head end responsive to the communications from the hardware peripheral device.

In any of the above embodiments, the peripheral device may be integrated into a single unit with the modem, or it may be a separate unit from the modem and connected to an input port on the modem, for example, a USB port or an Ethernet port. The peripheral device may use an infrared (IF) link or a radio frequency (RF) link to control the television information signal on the cable television network. The device may further include a status indicator section showing a current status of the peripheral device, for example, using light emitting diodes (LED's) or a liquid crystal display (LCD).

### BRIEF DESCRIPTION OF THE DRAWINGS

The present invention will be more readily understood by reference to the following detailed description taken with the accompanying drawings, in which:

FIG. 1 shows functional blocks of a cable television network according to one embodiment of the present invention.

FIG. 2 shows functional blocks of a peripheral device according to one embodiment of the present invention.

FIG. 3 shows functional blocks of a cable television network according to a second embodiment of the present invention.

### DETAILED DESCRIPTION OF SPECIFIC EMBODIMENTS

For the purposes of the description herein and the claims that follow it, unless the context otherwise requires, the terms “cable television network” and “cable television system” include all integrated systems for delivery of any information service to subscribers for use in connection with their televisions. These include conventional cable television systems utilizing coaxial cable for distribution primarily of broadcast and paid television programming, as well as cable television systems using fiber optics and other means for distribution of information services to subscribers.

Similarly, unless the context otherwise requires, the term “cable television service” includes any service or signal capable of being furnished to a television viewer having an interface permitting (but not necessarily requiring) interaction with a facility of the cable provider, including but not limited to an interactive information service, Internet, video on demand, local origination service, community event service, regular broadcast service, etc. “Interactive television service” means an information service that utilizes an interface affording two-way communication with a facility of the cable provider.

Embodiments of the present invention are directed to providing interactive cable television service by using a peripheral attached to a modem of another communication network entering the home. Examples of such other communication networks would include computer networks providing over the television cable, a second separate cable, or a DSL line. Such networks are accessed by a computer modem such as a cable modem or a DSL modem. The peripheral provides a cost-effective way to transmit data such as keystrokes and remote control selections from the home, back upstream to the head end of the cable television operator. This avoids requiring an expensive proprietary return path as used with set top boxes in the prior art.

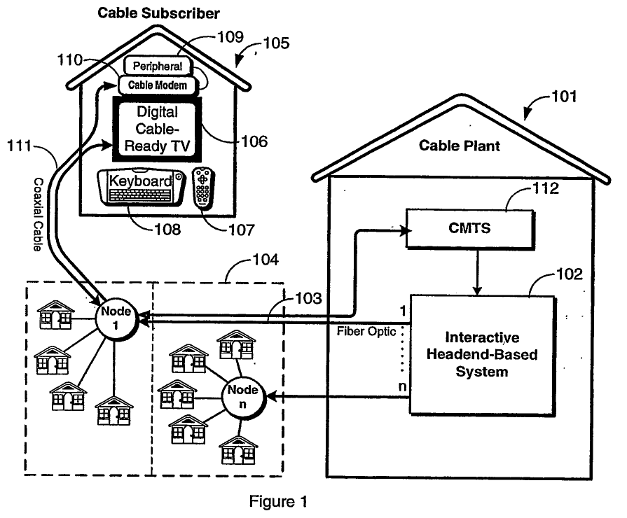

FIG. 1 shows functional blocks of a cable television system according to one embodiment of the present invention. Cable plant 101 includes the head end 102 of an interactive cable television network 103. The head end 102 distributes cable television services downstream over the cable television network 103 to various distribution nodes 104, which in turn provide cable television service to multiple end user premises 105. In many existing cable television systems a hybrid fiber-coax (HFC) network is used. The portion of the cable television network 103 that is upstream of the distribution nodes 104 may use fiber optic cable, while the portion of the cable television network 103 that is downstream of the distribution nodes 104 (i.e., into the subscriber homes) may use coaxial cable.

As shown in FIG. 1, the cable television service is provided directly to a digital cable ready television 106 at the user premises 105. To use interactive services such as video-on-demand (VOD), subscriber input data must be communicated back up to the cable operator head end 102. Such input data may be provided by a variety of devices including a remote control 107 and/or a keyboard 108.

Embodiments of the present invention provide this user data via a second communication network distinct from the cable television network 103 that receives the user data from a peripheral device 109, which acts as an interface between the subscriber 105 and the second communication network. In the specific embodiment shown in FIG. 1, the peripheral device 109 interfaces with a cable modem 110, which communicates via a coaxial cable 111 back upstream to a cable modem termination system (CMTS) 112 in communication with the cable television network head end 102 in the cable plant 101. The cable television network 103 may use physically separate or the same physical cable as the computer network.

The CMTS 112 is a system of devices that allows cable television operators to offer high-speed Internet access to home computers. The CMTS 112 sends and receives digital cable modem signals on a cable network, receiving signals sent upstream from a subscriber's cable modem 110, converting the signals into IP packets and routing the signals to an Internet Service Provide (ISP) for connection to the Internet. The CMTS 112 also can send signals downstream to the subscriber's cable modem 110. Individual cable modems 110 cannot communicate directly with each other; they must communicate by channeling their signals through the CMTS 112.

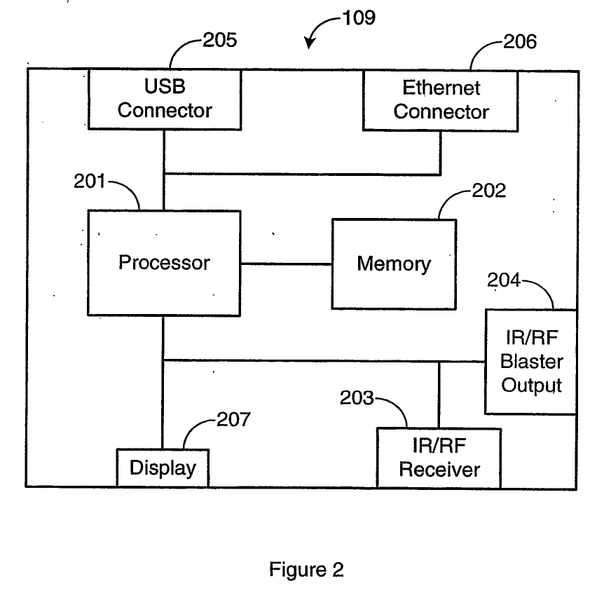

FIG. 2 shows various functional blocks of a peripheral device 109 according to one embodiment of the present invention. A peripheral processor 201 uses internal memory 202, which can store routing information to direct user provided data as IP packets to a specific computer network address. The memory 202 may also store information pertaining to an upstream computer network address from which a command originated.

Processor 201 controls communication of user data (e.g., from a keyboard, remote control, mouse, joystick, etc.), which is received from a user data input port such as receiver 203. The user data input port may use, for example, a wireless communication channel such as infrared (IR) or radio frequency (RF) electromagnetic energy. Control signals from the processor 201 out to the user television are communicated over a control output port such as blaster output 204, which again may typically use IR or RF techniques. The blaster output is used to force-tune a television set or a set-top box controlling the video on the television set to a specific channel in response to selections made by a user through the peripheral device 109. For example, if an IR frequency is required to force-tune a user's television set, then the IR blaster would basically be connected at one end to the peripheral device 109 and an extension cord with an IR transmitter at the other end pointed towards the IR receiver that tunes the television channels (i.e. set-top box or television). However, if a cable operator has the capabilities to force-tune a television set from the head end without requiring the television to be tuned inside the user's home, then the blaster output 204 would not be required.

As a user sends commands to the peripheral device 109, the commands are programmed through memory 202 to be sent to the interactive head end-based system 102. The interactive head end-based system processes the user's commands and can then provide an instant response to the user in the form of: a) video data in response to the user's selection; and/or b) sending a signal back up to the modem to force tune the television set to a particular channel, thereby satisfying the request of the user instantly.

The ability of a television tuner in a digital cable-ready television 106 (or a digital cable set-top box) to tune to a particular digital signal transmission is provided for by the transmission of a data packet to the television 106 which describes the location (frequency and identification number—“PID”) of a digital video source and digital audio source in the signal stream on the coaxial cable 11 of the cable television network 103. This data packet is often referred to as a “channel map.” Generally, the channel map provides information on all globally available digital cable transmissions. The channel map is used to control the selection of digital content by the user. If a channel selected by the user has information in the channel map, then the tuner permits tuning of the television 106 to that audio and video source. A digital cable ready television 106 can also be instructed to tune to a particular digital video and audio source which is not in the channel map, by a specific instruction from the cable head end 102 or a special purpose remote device. These instructions circumvent the validation of the of the channel information in the channel map and “force-tune” the tuner receiver to the required frequency and PID.

Thus, embodiments are capable of issuing these commands to a digital tuner within the digital cable ready television 106 through an IR interface such as the blaster output 204. Embodiments may also pass an authorization code to the digital tuner within the television 106 which must match an identical code that the tuner receives from the cable head end 102. If the code matches, the tuner tunes to the frequency and identification number specified.

In some embodiments, peripheral device 109 may be a separate physical unit from the cable modem 110. In such an embodiment, the processor 201 communicates with the cable modem 110 via a standard interface connector such as a USB connector 205 or an Ethernet port 206. In other embodiments, peripheral device 109 may be physically integrated with the cable modem 110, in which case, the USB connector 205 and/or Ethernet port 206 may be omitted.

In one embodiment, the peripheral device 109 also may include a peripheral device display 207 which shows the operational status of the peripheral device 109. The display 207 may use, for example, one or more LED's or an LCD screen.

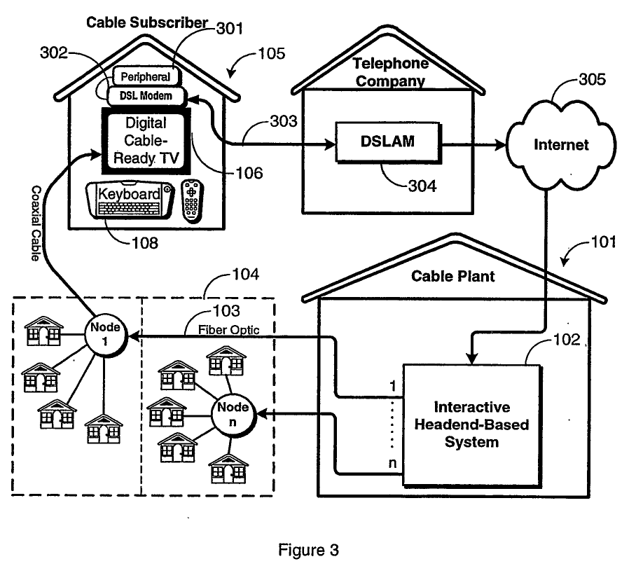

FIG. 3 shows functional blocks of a cable television network according to a second embodiment of the present invention. The downstream cable television network from the cable plant 101 to the subscriber 105 is similar to FIG. 1, but the upstream user data path on the second network uses a computer digital subscriber line (DSL) network. Thus, the peripheral device 301 interfaces with a DSL modem 302, which communicates via an existing copper telephone wire 303 to a digital subscriber line access multiplexer (DSLAM) at the telephone company. The DSLAM separates the voice-frequency telephone signals from the high-speed data traffic and controls and routes DSL data traffic between the subscriber 105 and the interactive head end 102 at the cable plant 101 via the Internet 305.

Although various exemplary embodiments of the invention have been disclosed, it should be apparent to those skilled in the art that various changes and modifications can be made which will achieve some of the advantages of the invention without departing from the true scope of the invention.

What is claimed is:

1. A device for use in an interactive cable television system, the device comprising:
a hardware peripheral device coupled to a computer modem at a user premises and in communication with a computer network, for communicating data from a user via the computer network to a cable television network head end to control a television information signal provided over a cable television network cable connected directly to a digital cable ready television at the user premises.

2. A device according to claim 1, wherein the peripheral device is integrated into a single unit with the computer modem.

3. A device according to claim 1, wherein the peripheral device is a separate unit from the computer modem and connected to an input port on the computer modem.

4. A device according to claim 1, wherein the peripheral device uses an infrared (IF) link for at least one of receiving the data from the user and controlling the television information signal.

5. A device according to claim 1, wherein the peripheral device uses a radio frequency (RF) link for at least one of receiving the data from the user and controlling the television information signal.

6. A device according to claim 1, further comprising:
a status indicator section showing a current status of the peripheral device.

7. A method for cable television system communication, the method comprising:
controlling a television information signal provided by a cable television network cable connected directly to a digital cable ready television at a user premises based on data communicated by a user to a peripheral device coupled to a computer modem at the user premises and in communication with a computer network, via the computer network to a cable television network head end.

8. A method according to claim 7, wherein the peripheral device is integrated into a single unit with the computer modem.

9. A method according to claim 7, wherein the peripheral device is a separate unit from the computer modem and connected to an input port on the computer modem.

10. A method according to claim 7, further comprising:
controlling the television information signal using an infrared (IF) link from the peripheral device.

11. A method according to claim 7, further comprising:
controlling the television information signal using a radio frequency (RF) link from the peripheral device.

12. A method according to claim 7, further comprising:
showing a current status of the peripheral device on a status indicator.

13. An interactive cable television system comprising:
a computer network;
a computer modem at a user premises in communication with the computer network;
a cable television network including a head end for providing a television information signal over a cable television network cable directly to a digital cable ready television at the user premises, the television having a display responsive to the television information signal;
a hardware peripheral device coupled to the modem for communicating data from a user via the computer network to the head end to control the television information signal.

14. A system according to claim 13, wherein the peripheral device is integrated into a single unit with the computer modem.

15. A system according to claim 13, wherein the peripheral device is a separate unit from the computer modem and connected to an input port on the computer modem.

16. A system according to claim 13, wherein the peripheral device uses an infrared (IF) link for at least one of receiving the data from the user and controlling the television information signal.

17. A system according to claim 13, wherein the peripheral device uses a radio frequency (RF) link for at least one of receiving the data from the user and controlling the television information signal.

18. A system according to claim 13, further comprising:
a status indicator section showing a current status of the peripheral device.

19. A device for use in an interactive cable television system, the device comprising:
a hardware peripheral device having:
i. a receiver for receiving data from a user input device,
ii. a processor responsive to the data for sending communications through a computer modem at a user premises over a computer network to a cable television network head end, and
iii. an output for controlling a television information signal:
(a) provided by a cable television network cable connected directly to a digital cable ready television at the user premises,
(b) from the head end responsive to the communications from the hardware peripheral device.

20. A device according to claim 19, wherein the peripheral device is integrated into a single unit with the computer modem.

21. A device according to claim 19, wherein the peripheral device is a separate unit from the computer modem and connected to an input port on the computer modem.

22. A device according to claim 19, wherein the peripheral device uses an infrared (IF) link for at least one of receiving the data from the user and controlling the television.

23. A device according to claim 19, wherein the peripheral device uses a radio frequency (RF) link for at least one of receiving the data from the user and controlling the television.

24. A device according to claim 19, further comprising:
a status indicator section showing a current status of the peripheral device.

25. An interactive cable television system comprising:
a computer modem at a user premises and in communication with a computer network;
a user input device;
a hardware peripheral device having:
i. a receiver for receiving data from the user input device, and
ii. a processor responsive to the data for sending communications through the computer modem to a cable head end; and
a digital cable ready television at the user premises and directly connected to a cable television network cable for displaying a television information signal provided over the cable from the head end controlled by the communications from the hardware peripheral device.

26. A system according to claim 25, wherein the peripheral device is integrated into a single unit with the computer modem.

27. A system according to claim 25, wherein the peripheral device is a separate unit from the computer modem and connected to an input port on the computer modem.

28. A system according to claim 25, wherein the peripheral device uses an infrared (IF) link for at least one of receiving the data from the user and controlling the television information signal.

29. A system according to claim 25, wherein the peripheral device uses a radio frequency (RF) link for at least one of receiving the data from the user and controlling the television information signal.

30. A system according to claim 25, further comprising:
a status indicator section showing a current status of the peripheral device.
